(19) United States
(12) Patent Application Publication
(10) Pub. No.: US 2004/0160736 A1
(43) Pub. Date: Aug. 19, 2004

(54) Portable computer

(76) Inventor: Cheng-Chih Lin, Taichung (TW)

Correspondence Address: Cheng-Chih Lin, 58, MA YUAN WEST ST., TAICHUNG, TW

(21) Appl. No.: 10/370,322

(22) Filed: Feb. 13, 2003

(51) Int. Cl. G06F 1/16

(52) U.S. Cl. 361/683; 361/681

(57) ABSTRACT

A portable computer has a main frame, a liftable monitor set, and at least a pivot joint connected to the main frame and the liftable monitor set. The monitor set has a first video display, a second video display, and a panel disposed between the first video display and the second video display. The main frame has a keyboard and a cursor device.

### BACKGROUND OF THE INVENTION

The present invention relates to a portable computer. More particularly, the present invention relates to a portable computer which has a monitor set having a plurality of video displays to facilitate two or more users to watch the monitor set clearly.

A conventional monitor has a single video display only. Two or more users should be squeezed together in order to watch the video display clearly.

### SUMMARY OF THE INVENTION

An object of the present invention is to provide a portable computer which has a monitor set having a plurality of video displays to facilitate two or more users to watch the monitor set clearly.

Accordingly, a portable computer comprises a main frame, a liftable monitor set, and at least a pivot joint connected to the main frame and the liftable monitor set. The monitor set has a first video display and a second video display attached to the first video display.

In accordance with a first preferred embodiment of the present invention, a portable computer comprises a main frame, a liftable monitor set, and at least a pivot joint connected to the main frame and the liftable monitor set. The monitor set has a first video display, a second video display, and a panel disposed between the first video display and the second video display. The main frame has a keyboard and a cursor device.

In accordance with a second preferred embodiment of the present invention, a portable computer comprises a main frame, a liftable monitor set, and at least a first pivot joint connected to the main frame and the liftable monitor set. The monitor set has a first video display, a second video display, a first panel disposed on a back of the first video display, a second panel disposed on a back of the second video display, and at least a second pivot joint connected to the first panel and the second panel. When the monitor set is lifted, the monitor set is in an inverse V shape. The main frame has a keyboard and a cursor device.

### BRIEF DESCRIPTION OF THE DRAWINGS

FIG. 1 is a perspective view of a portable computer of a first preferred embodiment in accordance with the present invention;

FIG. 2 is another perspective view of a portable computer of a first preferred embodiment in accordance with the present invention; and

FIG. 3 is a perspective view of a portable computer of a second preferred embodiment in accordance with the present invention.

### DETAILED DESCRIPTION OF THE INVENTION

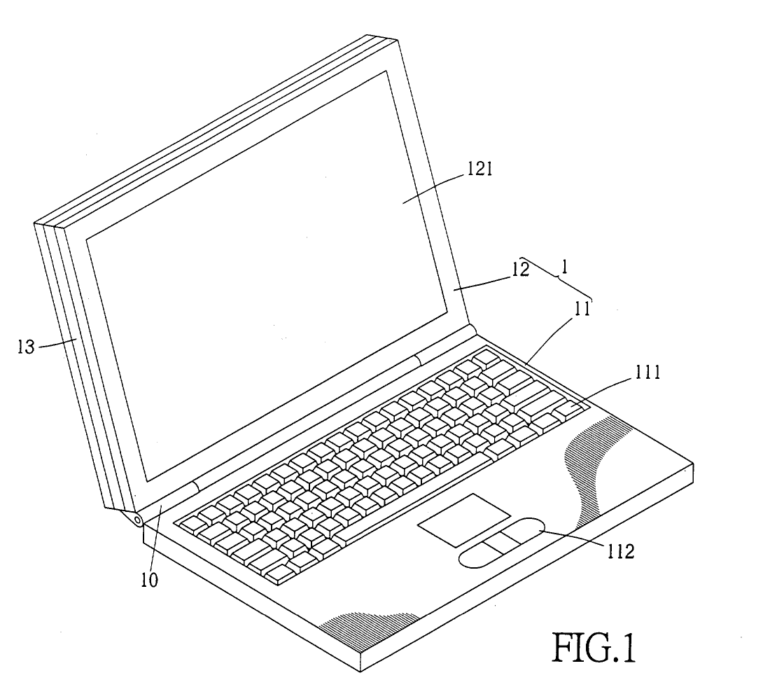

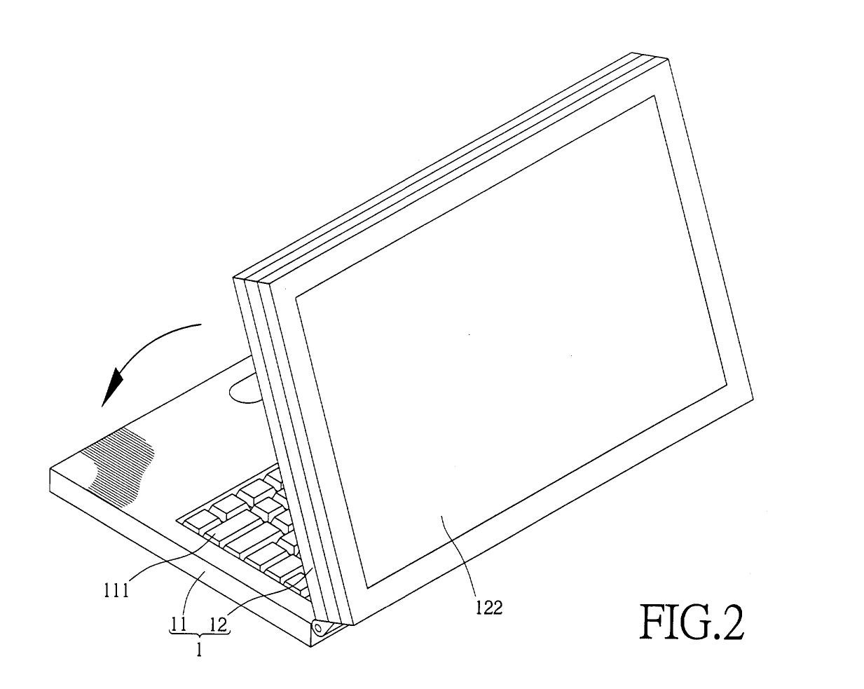

Referring to FIGS. 1 and 2, a portable computer 1 comprises a main frame 11, a liftable monitor set 12, and at least a pivot joint 10 connected to the main frame 11 and the liftable monitor set 12.

The monitor set 12 has a first video display 121, a second video display 122, and a panel 13 disposed between the first video display 121 and the second video display 122.

A first user watches the first video display 121, and a second user watches the second video display 122.

The main frame 11 has a keyboard 111 and a cursor device 112.

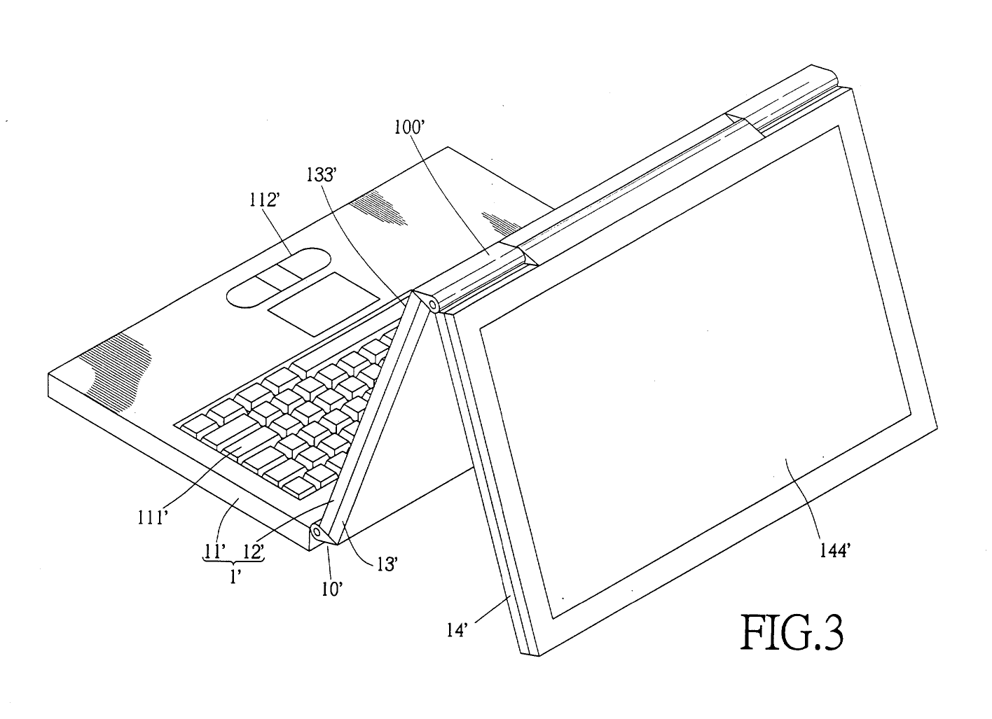

Referring to FIG. 3, another portable computer 1′ comprises a main frame 11′, a liftable monitor set 12′, and at least a first pivot joint 10′ connected to the main frame 11′ and the liftable monitor set 12′.

The monitor set 12′ has a first video display 133′, a second video display 144′, a first panel 13′ disposed on a back of the first video display 121′, a second panel 14′ disposed on a back of the second video display 122′, and at least a second pivot joint 100′ connected to the first panel 13′ and the second panel 14′.

When the monitor set 12′ is lifted, the monitor set 12′ is in an inverse V shape.

The main frame 11′ has a keyboard 111′ and a cursor device 112′.

The invention is not limited to the above embodiment but various modification thereof may be made. Further, various changes in form and detail may be made without departing from the scope of the invention.

I claim:

1. A portable computer comprising a main frame, a liftable monitor set, and at least a pivot joint connected to the main frame and the liftable monitor set, characterized in that:
the monitor set has a first video display and a second video display attached to the first video display.

2. The portable computer as claimed in claim 1, wherein a panel is disposed between the first video display and the second video display.

3. A portable computer comprising a main frame, a liftable monitor set, and at least a first pivot joint connected to the main frame and the liftable monitor set, characterized in that:
the monitor set has a first video display, a second video display, a first panel disposed on a back of the first video display, a second panel disposed on a back of the second video display, and at least a second pivot joint connected to the first panel and the second panel, and
when the monitor set is lifted, the monitor set is in an inverse V shape.
